(19) United States
(12) Patent Application Publication
(10) Pub. No.: US 2024/0231700 A1
(43) Pub. Date: Jul. 11, 2024

(54) SYSTEMS AND TECHNIQUES FOR TRANSFER OF DIRTY DATA

(71) Applicant: Micron Technology, Inc., Boise, ID (US)

(72) Inventor: Wenjun Wu, Shanghai (CN)

(21) Appl. No.: 18/520,169

(22) Filed: Nov. 27, 2023

Related U.S. Application Data
(60) Provisional application No. 63/438,448, filed on Jan. 11, 2023.

(51) Int. Cl. G06F 3/06

(52) U.S. Cl. CPC G06F 3/0659; G06F 3/0604; G06F 3/0647; G06F 3/0679

(57) ABSTRACT

Methods, systems, and devices for systems and techniques for transfer of dirty data are described. A memory system may include a memory device including a first controller, and a second controller coupled with the memory device. The second controller may issue, to the first controller, a command to sense data stored at one or more planes of the memory device. In response, the data from the one or more planes may be transferred to an interface between the one or more planes and the second controller. The second controller may issue, to the first controller, a command to transfer one or more portions of the data to the second controller that includes a bitmap indicating the one or more portions of the data. In response, the one or more portions of the data may be transferred to the second controller via the interface in accordance with the bitmap.

### CROSS REFERENCE

The present application for patent claims the benefit of U.S. Provisional Patent Application No. 63/438,448 by W U et al., entitled “SYSTEMS AND TECHNIQUES FOR TRANSFER OF DIRTY DATA,” filed Jan. 11, 2023, assigned to the assignee hereof, and expressly incorporated by reference herein.

### FIELD OF TECHNOLOGY

The following relates to one or more systems for memory, including systems and techniques for transfer of dirty data.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIGS. 1, 2, and 3 illustrate examples of systems that support systems and techniques for transfer of dirty data in accordance with examples as disclosed herein.

FIG. 4 illustrates an example of a data diagram that supports systems and techniques for transfer of dirty data in accordance with examples as disclosed herein.

FIGS. 5, 6, and 7 illustrate examples of data transfer diagrams that support systems and techniques for transfer of dirty data in accordance with examples as disclosed herein.

FIG. 8 illustrates an example of a data transfer command that support systems and techniques for transfer of dirty data in accordance with examples as disclosed herein.

FIG. 9 illustrates a block diagram of a memory system that supports systems and techniques for transfer of dirty data in accordance with examples as disclosed herein.

FIG. 10 illustrates a flowchart showing a method or methods that support systems and techniques for transfer of dirty data in accordance with examples as disclosed herein.

### DETAILED DESCRIPTION

Methods, systems, and devices for systems and techniques for transfer of dirty data are described. Non-volatile memory devices, such as NAND memory devices (among others), may be internally organized into one or more planes that may be concurrently accessed. Data stored within a non-volatile memory device, such as a NAND device, may be addressed by a host system using logical addresses and stored to locations of the memory device using physical addresses. A memory system controller may maintain and utilize mapping data to translate these logical addresses to the physical addresses. Additionally, each time data is modified (e.g., updated, overwritten) and stored to the memory device, the physical address may change for the data. As such, data stored within a logical block as understood by the host system may be physically stored across pages that are physically located at various portions of the memory device. In some examples, when data is first stored to a memory system, a logical block of data may be stored contiguously within a memory device of the memory system (e.g., contiguous with respect to one or more pagelines). This data may be considered “clean” data. Over time, portions of the data may be increasingly located at various portions of the memory device, for example, due to modification of the portions of the data. As a result, the data may no longer be contiguously stored, and non-contiguously stored data may be considered “dirty” data.

In some examples, reading a contiguous block of data stored within a logical block of data may include reading a pageline of data, where a pageline may correspond to a same page within the planes of a virtual block of data. The data of the pageline may be read from the corresponding planes into an interface via which the memory device may communicate with the memory system controller (e.g., a set of one or more latches of the interface configured to temporarily store the data). After the transfer to the interface, the data may be transferred to the memory system controller using a high-speed data transfer. In some cases, individual chunks of data from within a pageline may be stored non-contiguously, for example based on modification of the chunks of data. The quantity of data chunks within the pageline that are stored in different locations of the memory system may correspond to how “dirty” the memory currently is. The level of dirty memory within the memory device may impact the performance of the memory device as more than one command may be issued to transfer the data chunks to the memory system controller via the interface.

For example, the memory system controller may identify which data chunks read to the latches are valid and transfer the valid data chunks while skipping the transfer of invalid data chunks. However, to skip the transfer of an invalid data chunk, the memory system controller may issue an explicit command (e.g., a change column command) to reset an offset of the latches from which to transfer data such that the invalid data chunk is skipped. Thus, the retrieval of a page of data may take multiple commands to transfer the data from latches within the memory device (e.g., the interface) to the memory system controller, which increases signaling overhead and increases latency to associated with retrieving data from the memory device.

Implementations described herein address the aforementioned shortcomings and other shortcomings by providing a single transfer command that supports transferring valid data chunks while skipping the transfer of invalid data chunks, thereby reducing signaling overhead and latency associated with the data transfer, among other benefits. For example, the single transfer command may include a bitmap in which each bit within the bitmap corresponds to a data chunk of data retrieved from one or more planes to the interface for communicating data between a memory device and a memory system controller. Data from the data chunks corresponding to a ‘1’ (e.g., or ‘0’) in the bitmap may transferred via the interface as part of a single high speed data transfer. The data from data chunks corresponding to a ‘0’ (e.g., or ‘1’) may be excluded from the data transfer. The data transfer via the interface (e.g., from one or more latches of the interface) may be performed as a single data transfer sequence in which the data excluded from being transferred is automatically skipped. The skipping of a data chunk may be accomplished by setting (e.g., adjusting, moving) the position of an internal data cursor (e.g., pointer) that indicates the data to be transferred. In some examples, the data cursor may be moved to an address within the latch corresponding to a next data chunk to be transferred after a data chunk is transferred. The data cursor may be moved to skip data chunks corresponding to ‘0’s in the bitmap. Thus, the transfer of valid data chunks while skipping the transfer invalid data chunks may be supported.

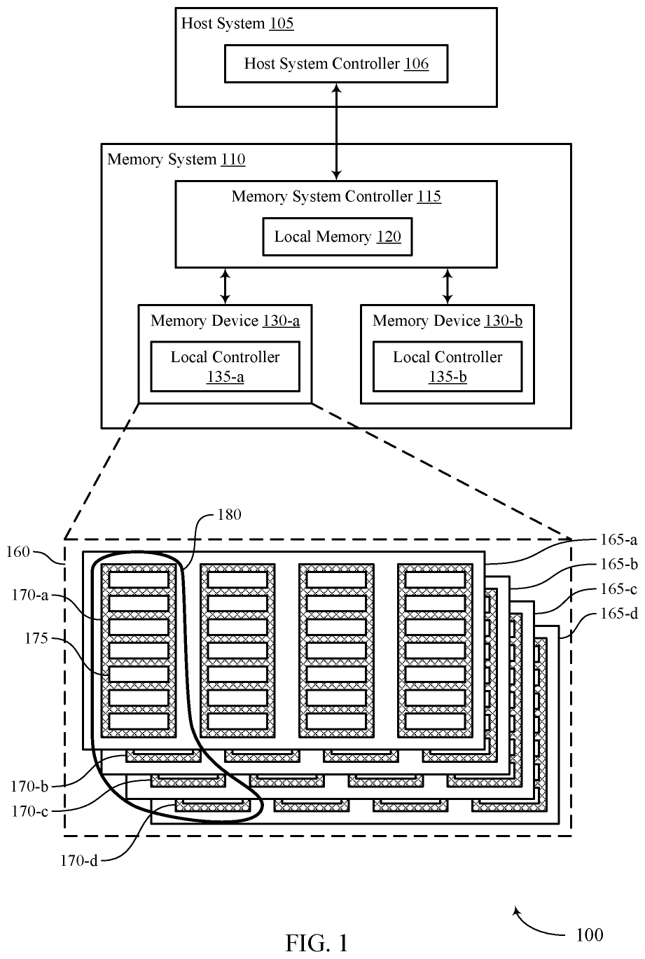

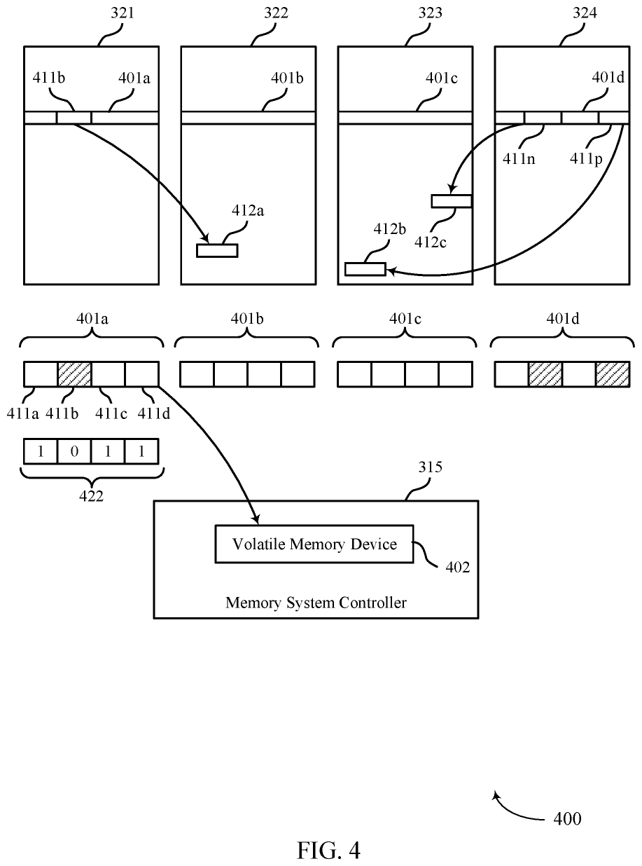

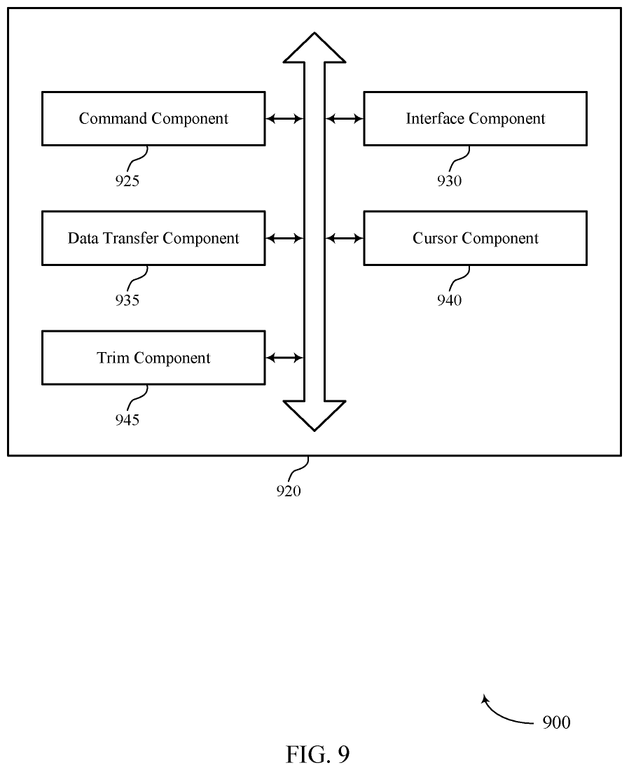

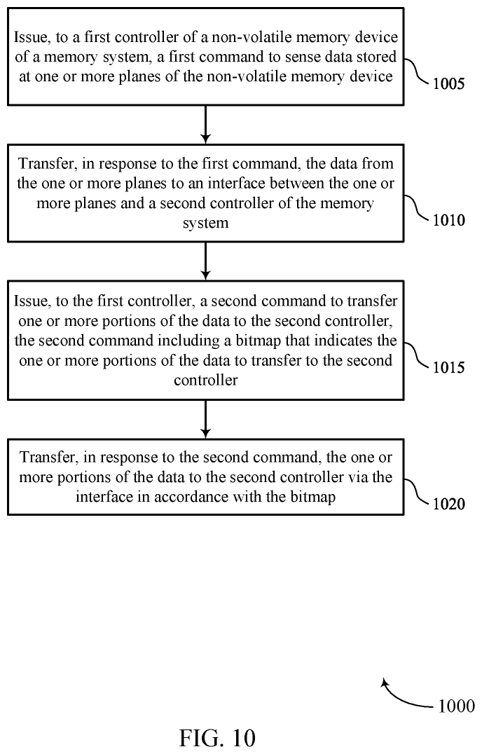

Features of the disclosure are initially described in the context of systems with reference to FIGS. 1 through 3. Features of the disclosure are described in the context of a diagram, data transfer diagrams, and a data transfer command with reference to FIGS. 4 through 8. These and other features of the disclosure are further illustrated by and described in the context of an apparatus diagram and flowchart that relate to systems and techniques for transfer of dirty data with reference to FIGS. 9 through 10.

FIG. 1 illustrates an example of a system 100 that supports systems and techniques for transfer of dirty data in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a universal flash storage (UFS) device, an embedded multi-media controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT)-enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a fiber channel interface, a small computer system interface (SCSI), a serial attached SCSI (SAS), a double data rate (DDR) interface, a DIMM interface (e.g., DIMM socket interface that supports DDR), an Open NAND flash interface (ONFI), and a low power double data rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, spin transfer torque (STT)-MRAM, conductive bridging RAM (CBRAM), resistive random access memory (RRAM), oxide-based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new; valid block 170 rather than the old, invalid block 170. In some cases, such copying and remapping may be performed instead of erasing and rewriting the entire old block 170 due to latency or wear out considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory array's and related circuitry combined with a local (e.g., on-die or in-package) controller (e.g., local controller 135). An example of a managed memory system is a managed NAND (MNAND) system.

The system 100 may include any quantity of non-transitory computer readable media that support systems and techniques for transfer of dirty data. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

Commands may be generated and transmitted to a memory device 130 by the memory system controller 115 to perform various operations. In some examples, these commands may be received by a local controller 135 to request data transfer operations from the memory device 130 to the memory system controller 115. Data may be retrieved from the memory device 130 and transferred to the memory system controller 115 via an interface for communicating data between the memory device 130 and the memory system controller 115 (e.g., an Open NAND Flash Interface (ONFI) channel).

To support reduced latency and signaling overhead associated with the transfer of data from the memory device 130 to the memory system controller 115, the memory system controller 115 may issue a transfer command that includes a bitmap indicating which portions of data retrieved from the memory device 130 to the interface are to be transferred via the interface and which portions of the data are to be excluded from being transferred. In this way, portions of the data including valid data may be transferred while portions of data including invalid data may be automatically skipped in response to a single transfer command, thereby reducing signaling overhead and latency associated with the data transfer.

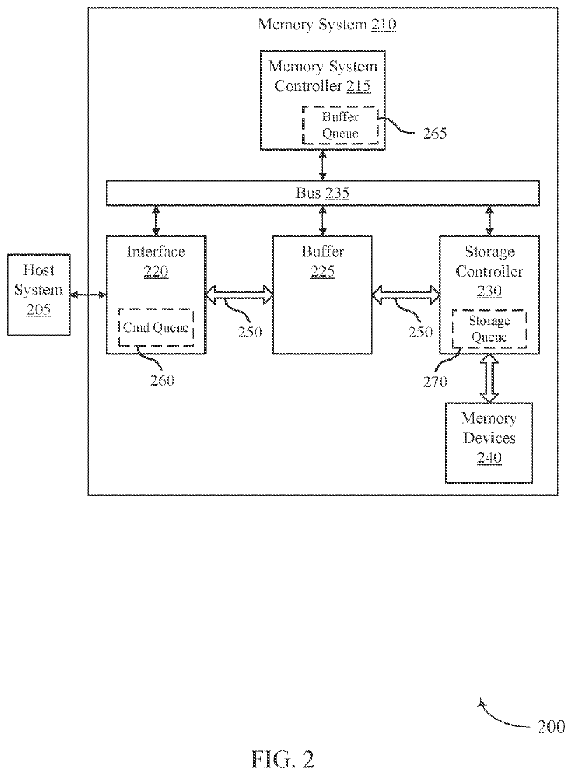

FIG. 2 illustrates an example of a system 200 that supports systems and techniques for transfer of dirty data in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260), a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270) are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. The memory system controller 215 may use the buffer 225 for, among other things, temporary storage of the data being received from or sent to the host system 205. The buffer 225 may be considered a middle end of the memory system 210.

In some cases, a buffer queue 265 may be used to control a flow of commands associated with data stored in the buffer 225, including write commands and read commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, a storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260. The storage controller 230 may be considered a back end of the memory system 210.

Once the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

To support reduced latency and signaling overhead associated with the transfer of data from a memory device 240 to the buffer 225, the memory system controller 215 may issue a single transfer command to transfer valid data from the memory device 240 to the buffer 225. The data transfer may be specified by a bitmap included in the single transfer command in which each data chunk is designated for or excluded from transfer to the buffer 225 by a corresponding bit within the bitmap. In this way, data chunks including valid data may be transferred while data chunks including invalid data may be automatically skipped in accordance with the bitmap, thereby reducing signaling overhead and latency associated with the data transfer by supporting such data transfers using the single transfer command

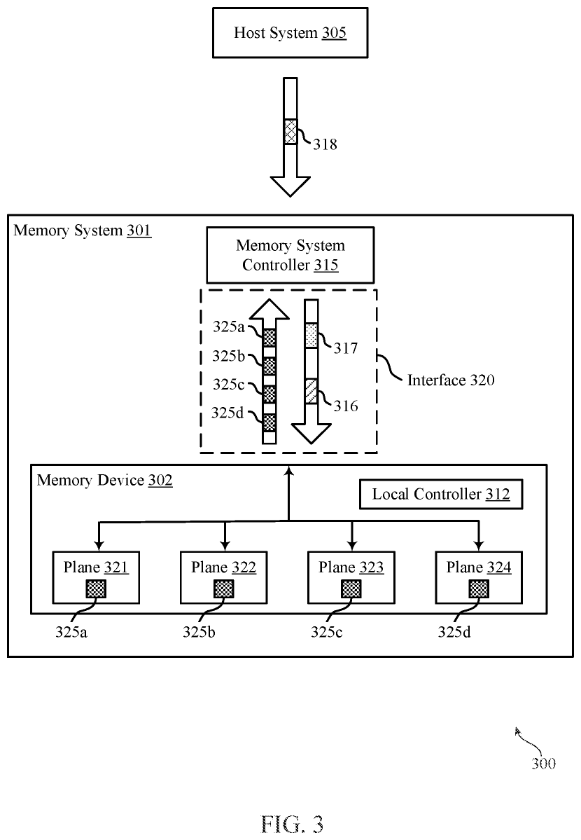

FIG. 3 illustrates an example of a system 300 that supports systems and techniques for transfer of dirty data in accordance with examples as disclosed herein. The system 300 may implement or be implemented by aspects of the systems 100 and 200 described with reference to FIGS. 1 and 2. For example, the system 300 may include a host system 305 and a memory system 301, which may be examples of the corresponding systems described herein, including with reference to FIGS. 1 and 2.

In FIG. 3, the host system 305 may be coupled with the memory system 301 to enable the host system 305 to read data from and write data to one or more memory devices 302 of the memory system 301. The memory system 301 may include a memory system controller 315 and one or more memory devices 302. The memory system 301 may support reading data stored to the memory devices 302 for various purposes, such as in response to read commands issued by the host system 305 or as part of a media management operation. For example, the host system 305 may issue a read command to the memory system 301 (e.g., the memory system controller 315) causing the memory system controller 315 to obtain the requested data from the memory device 302 and transmit the data to the host system. Additionally or alternatively, the memory system controller 315 may read data from the memory device 302 as part of a media management operation to transfer the data between memory devices 302 or between respective portions of the memory device 302 (e.g., pages, blocks, virtual blocks, planes, and the like) In some examples, a series of read operations may utilize non-contiguous logical addresses for each of the individual read operations. In some other examples, a series of read operations may utilize a series of sequential logical addresses.

A series of read operations (e.g., or a single read operation) may cause data 325 to be obtained from planes, such as planes 321-324, that are within the memory device 302. The memory device 302 may include a local controller 312 and any quantity of planes, such as planes 321-324. The local controller 312 may receive a command issued by the memory system controller 315 to obtain a block of data from the planes 321-324 via an interface 320. For example, the memory system 301 may include an interface 320 via which information may be communicated between the memory system controller 315 and the memory device 302. In some examples, the interface 320 may include one or more channels (e.g., data pipelines, ONFI channels) via which commands or data may be communicated. In some examples, the interface 320 may include one or more latches (e.g., sets of memory cells) that may be configured to temporarily store data retrieved from the planes 321-324 prior to being transferred to the memory system controller 315.

The memory system controller 315 may issue a sense command 316 to the local controller 312 in response to which the local controller 312 may transfer data 325 to the interface 320. For example, the local controller 312 may cause one of the data 325a-d from the planes 321-324, respectively, to be temporarily stored to latches of the interface 320. The memory system controller 315 may issue a transfer command 317 to the local controller 312 in response to which the local controller 312 may cause the data 325 to be transferred to the memory system controller 315 via the interface 320. In some examples, such as part of a multi-plane read operation to read data 325 from multiple planes 321-324 (e.g., the data 325a-d), the local controller 312 may initiate the data transfer from the plane 321 followed by a series of data transfers from the remaining planes 322-324 after each prior data transfer ends. That is, data 325a from the plane 321 may be transferred via the interface 320 followed by data 325b-d from the planes 322-324, respectively.

Each data 325 may include (e.g., be divided into) one or more data chunks. For example, the data 325 may correspond to a page of data of a corresponding plane. In some examples, a page may include at least a first quantity of storage (e.g., 16 kilobyte (KB), among other quantities of storage). A translation unit may correspond to a data granularity associated with the type of memory system (e.g., a granularity at which data may be written, read, or both). For example, a translation unit may correspond to a second quantity of storage (e.g., 4 KB for UFS, 512 B for eMMC) from which data may be read or to which data may be written. In some examples, the translation units may represent a minimal amount of data pointed to by entries of a flash translation layer (FTL) table. In some cases, logical translation units (e.g., logical addresses of the translation units) may be used to indicate data at a logical level (e.g., at a host and controller level), and the translation units may be the physical locations at which the logical data is stored.

In some cases, one or more of the data chunks of the data 325 may include invalid data. The invalid data chunks may be excluded from being transferred to the memory system controller 315 via the interface 320, while valid data chunks may be transferred via the interface 320. For example, data chunks of data 325 may be transferred to the interface 320) (e.g., a latch of the interface 320) in response to a sense command 316. The memory system controller 315 may issue a transfer command 317 in response to which the local controller 312 may cause one or more of the sensed data chunks of the data 325 to be transferred to the memory system controller 315 via the interface (e.g., from the latch to the memory system controller via a channel of the interface 320). For example, in response to a single transfer command 317, valid data chunks of respective data 325 may be transferred to the memory system controller 315 while invalid data chunks may be excluded (e.g., skipped) from the transfer.

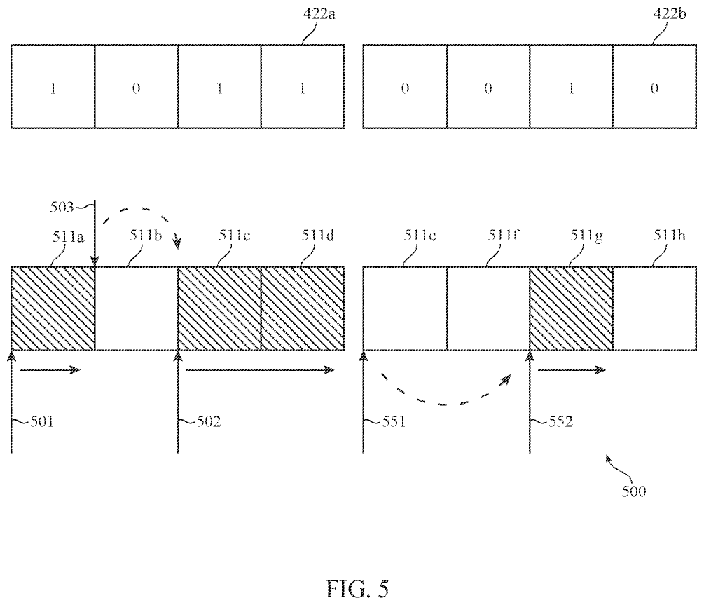

To support such data chunk transfer using a single transfer command 317, the memory system controller 315 may generate the transfer command 317 to include a bitmap that indicates which data chunks to transfer and which data chunks to skip. For example, the transfer command 317 may be generated in accordance with a validity of the data transferred to the interface 320. For instance, the memory system controller 315 may determine which data chunks of the data 325 are valid and which data chunks are invalid (e.g., using L2P mapping information, using page validity information) and generate the bitmap to indicate the transfer of valid data chunks and to skip the transfer of invalid data chunks. Thus, in response to the transfer command 317 that includes the bitmap, the local controller 312 may cause the transfer of the valid data chunks via the interface 320 and the skipping of the transfer of the invalid data chunks in accordance with the bitmap. In some examples, the local controller 312 may utilize an internal data cursor (e.g., pointer) to support skipping the transfer of the invalid data chunks as described with reference to FIG. 5.

A data chunk includes data for a page and may have a fixed size (e.g., approximately 4 KB for UFS, 512 B for eMMC). In some examples, different systems (e.g., host systems 305, memory systems 301) may utilize different fixed sizes for the data chunks. For example, different systems may implement different spare data sizes, which may result in different variations from, for example, the 4 KB data chunk size for UFS. In some examples, the fixed size of the data chunk may be indicated to the memory system 301 during initialization. For example, a trim command 318 may be received from the host system 305 (e.g., as part of an initialization procedure between the host system 305 and the memory system 301) that includes the size of the data chunks to be used.

FIG. 4 illustrates an example of a data diagram 400) that supports systems and techniques for transfer of dirty data in accordance with examples as disclosed herein. The data diagram 400 may be implemented by aspects of the systems 100, 200, and 300 described with reference to FIGS. 1 through 3. For example, the data diagram 400 may be implemented by a memory system, such as a memory system described herein, including with reference to FIGS. 1 through 3.

A particular pageline may include data chunks for data from each plane 321-324 of the memory device 302. For example, the pageline may include the data chunks of pages 401a-d from planes 321-324, respectively. Each page 401 may be divided into multiple data chunks (e.g., page 401-a may be divided into data chunks 411a-d, and so on). In some examples, data may be stored (e.g., written) to the pageline sequentially. For example, data may be sequentially written to the page 401a, then the page 401b, and so on. Storing the data sequentially may aid the transfer of the data using fewer access commands. In some examples, accessing the pages 401a-d of the pageline may occur in a single access command (e.g., a multiplane read command) and the data may be considered clean data.

When data within a given data chunk 411 is modified, updated data for the logical address corresponding to the data chunk 411 may be written to a different location of the memory device 302 and internal L2P mappings may be updated to indicate the new physical address for the logical address (e.g., the physical address to which the updated data is stored). For example, if data chunks 411b, 411n, and 411p are updated and written to new physical addresses 412a-c of the memory device 302, an L2P mapping may be updated to indicate the new physical addresses 412a-c of the logical data corresponding to the data chunks 411b, 411n, and 411p. The old physical address, such as the physical addresses of the data chunks 411b, n, p, may be marked as storing invalid data. It is noted that the updated data chunks 411 are depicted as being written to different location within the planes of the memory device 302 for clarity. In some examples, the updated data chunks 411 may be written to a different die of the memory device 302 or to a different memory device of the memory system 301.

Due to updating of data, accessing a sequential set of data originally stored to the pageline may include retrieving data from each current location in which the data chunks are located and stitching the sequence of data chunks in the sequence used when the set of data was first stored. If data chunks 411 (e.g., data chunks 411b, n, p) are located in physical addresses 412 excluded from the pageline (e.g., physical addresses 412a-c), an access command may be issued to retrieve the respective data chunks 411 from each of these locations. This arrangement of data chunks may be considered dirty data due to the modification and relocation of data chunks within the memory device 302. In some examples, a separate access command (e.g., an IWL16 KB command) that is specific to each page 401 may be issued based on the data being dirty to retrieve the data from the pages 401.

When a set of data chunks 411a-d from single plane 321 of page 401a is accessed, a transfer command (e.g., a transfer command 317) may implement a bitmap 422 to indicate what portion of the page 401a are to be retrieved. The portion of data to be accessed may include one or more data chunks 421a-d to be transferred to the memory system controller 315. The memory system controller 315 may determine which data chunks 411 include valid data and construct (e.g., generate) a corresponding bitmap 422. The local controller 312 may cause the memory device 302 to obtain (e.g., transfer, sense) the data chunks 411a-d and store the data chunks 411 into latches of the interface 320. The local controller 312 may then initiate a single data transfer from the latches to a volatile memory device 402 of the memory system controller 315 (e.g., local memory 120, SRAM), the data transfer including the data chunks 411a, c, d indicated by the bitmap 422 and excluding the data chunk 411b based on the physical address of the data chunk 411b in page 401a including invalid data. In some examples, the bitmap 422 may include bits corresponding to data chunks 411 of the pages 401b-d. Here, the local controller 312 may cause one or more data chunks 411 of pages 401b-d transferred to the latch of the interface 320 to be transferred to the memory system controller 315 in accordance with the bitmap 422. The memory system controller 315 may use the data chunks 411 transferred to the volatile memory device 402 to perform various operations. For example, the data chunks 411a-d may be combined with the data chunk 411b retrieved from the physical address 412 (e.g., and other data chunks 411 from other pages 401b-d) as part of creating a sequential arrangement of the data chunks of the pageline to provide the pageline to a host system or as part of a garbage collection, and among other operations.

FIG. 5 illustrates an example of a data transfer diagram 500 that supports systems and techniques for transfer of dirty data in accordance with examples as disclosed herein. The data transfer diagram 500 may be implemented by aspects of the systems 100, 200, and 300 described with reference to FIGS. 1 through 3. For example, the data diagram 400 may be implemented by a memory system, such as a memory system described herein, including with reference to FIGS. 1 through 4.

Data from a page, such as a page 401a-d, may be transferred from a plane, such as a plane 321-324, of the memory device 302 into a latch of the interface 320. A single transfer command 317 may include a bitmap 422 (e.g., a bitmap 422a, a bitmap 422b) that indicates which of the data chunks 411 transferred to the latch are to be transferred to the memory system controller 315 via the interface 320. In the example of FIG. 5, two planes (e.g., planes 321-322) may each store a page of data that include respective data chunks 511a-h that contain valid and invalid data as indicated by the bitmaps 422a-b.

Each page of data within the planes 321-324 may be divided into a quantity of data chunks (e.g., four data chunks, among other quantities) having a data chunk length (e.g., a data chunk size) specified by a trim command during an initialization of the memory system 301. In the example of FIG. 5, the memory system 301 may issue one or more sense commands 316 to the local controller 312 to sense (e.g., transfer) data stored at one or more planes of the memory device 302. For example, a first plane may store a first portion of the data, otherwise known as data chunk 0 511a, a second portion of the data, otherwise known as data chunk 2 511c, and a third portion of the data, otherwise known as data chunk 3 511d, are to be transferred to the memory system controller 315 from the latch in accordance with the bitmap 422a. A fourth portion of the data, otherwise known as data chunk 1 511b may be skipped in accordance with the bitmap 422a. A second plane may store a first additional portion of the data, otherwise known as data chunks 4-5 511e-f, a second additional portion of the data, otherwise known as data chunk 6 511g, and a third additional portion of data, otherwise known as data chunk 7 511h. In accordance with the bitmap 422b, the second additional portion of data, data chunk 6 421g, may be transferred to the memory system controller 315 from the latch and the remaining data chunks may be skipped.

In processing the first plane ((e.g., managing the transfer of data chunks 511a-d to the memory system controller 315), the local controller 312 of the memory device 302 may implement a cursor, or address pointer, to contain (e.g., point to) an address within the latch to which the data chunks 511a-d are stored. A position of the cursor (e.g., the address pointed to by the cursor) may be set to (e.g., point to) a location 501 corresponding to the beginning of the data chunk 511a when the transfer of the data from the first plane to the memory system controller 315 is initiated. As the first portion of data (e.g., data chunk 0 511a) is being transferred, the position of the cursor points to an address of data byte to be sent. The position may be incremented until the position of the cursor reaches an end of the data chunk 0) 511a corresponding to a location 503. That is, the position of the cursor may be at an end of the data chunk 0 511a and a beginning of the data chunk 1 511b after transferring the data chunk 0 511a. Data chunk 1 511b is marked in the bitmap 422a with a 0, thus data chunk 1 511b is skipped. To support such skipping, the memory system 301 (e.g., the local controller 312) may set the position of the cursor to a location 502 corresponding to the start of data chunk 2 511c to continue the data transfer to the memory system controller 315 using data chunk 2 511c and data chunk 3 511d. When the cursor reaches the end of data chunk 2 421c, the transfer may continue through data chunk 3 421d in accordance with the bitmap 422a. The transfer of data chunk 0 511z, data chunk 2 511c, and data chunk 3 511d occurs in response to a single transfer command 317 received from the memory system controller 315 that includes the bitmap 422a.

In processing the second plane, the local controller 312 may implement the cursor. For example, a position of the cursor may correspond to (e.g., be set to) a location 551, for example, after data from the first plane has been transferred, and the location 551 may be the beginning of the data obtained from second plane. The local controller 312 may use the bitmap 422b (e.g., included a same or different transfer command 317) to determine that the first additional portion of data (e.g., data chunks 511e-f) is to be skipped and may set the position of the cursor to a location 552 corresponding to the start of the second portion of data (e.g., data chunk 6 511g). The data in the second additional portion of data 511g is then transferred. After the transfer is complete, the position of the cursor may be located at the start of the third additional portion of data (e.g., data chunk 7 511h), which may be skipped (e.g., and moved to a beginning of data from a next plane with the process continuing as described above based upon the bits within respective bitmaps 422).

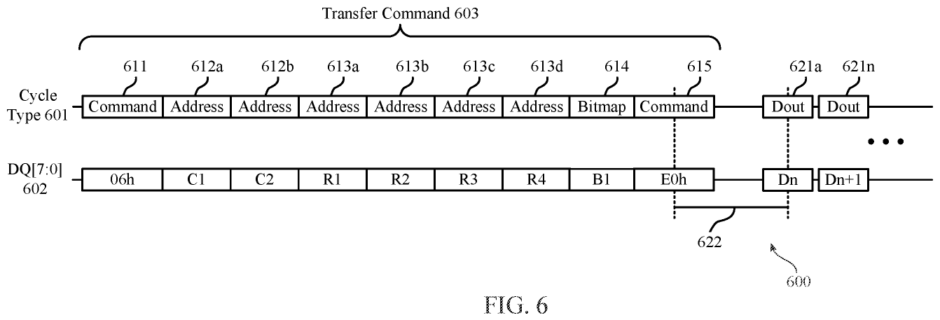

FIG. 6 illustrates an example of data transfer diagram 600 that supports multiplane data transfer commands in accordance with examples as disclosed herein. The data transfer diagram 600 may be implemented by aspects of the systems 100, 200, and 300 described with reference to FIGS. 1 through 3. For example, the data transfer diagram 600 may be implemented by a memory system, such as a memory system described herein, including with reference to FIGS. 1 through 5.

The data transfer diagram 600 depicts a timing of a single transfer command 603 (e.g., a transfer command 317) in response to which data retrieved from one or more planes may be transferred to the memory system controller 315. Timing of signals D[7:0] 602 and the corresponding cycle type 601 for the single transfer command 603 define data signals D[7:0] 602 into and out of a memory device 302 during the occurrence of a particular read operation.

The transfer command 603 may begin with the transmission of a command header (06 h) 611 to initiate transmission of the read command. In the example of FIG. 6, a pair of column addresses 612a-b (e.g., column address bytes) may be transmitted over data signals D[7:0] 502 following the command header (06 h) 611. Four row addresses 613a-d (e.g., row address bytes) are transmitted over data signals D[7:0] 602 following the column addresses 612a-b. In some examples, the address indicated by the transfer command 603 may be an address of a plane from which corresponding data is transferred to the memory system controller 315. A bitmap 614 may be transmitted over one or more of the data signals D[7:0] 602 (e.g., depicted as following the column addresses 613, although the bitmap 614 may be included elsewhere within the transfer command 603). The bitmap 615 may indicate which data chunks 621 retrieved from the one or more planes are to be transferred to the memory system controller 315 and which data chunks 621 are to be skipped. A command tail (E0 h) 615 may end the transmission of the transfer command 603.

Portions of the transfer command 603 may be sent over respective unit intervals. For example, the row addresses 612, the column addresses 613, and the bitmap 614 may be issued over unit intervals, where a unit interval may correspond to a cycle of the transfer command. For example, in a single data rate (SDR) system, a unit interval may refer to an entire cycle of a clock signal. In a double-date rate (DDR) system, a unit interval may refer to a rising edge of the clock signal or a falling edge of the clock signal.

Data chunks retrieved from the memory device 302 is shown as a sequence of bytes 621a-n after a delay tCCS 622. The tCCS 622 may correspond to a time taken to transfer (e.g., sense, retrieve, read) data from a plane to the interface 320 after which the data may be transferred to the memory system controller 315.

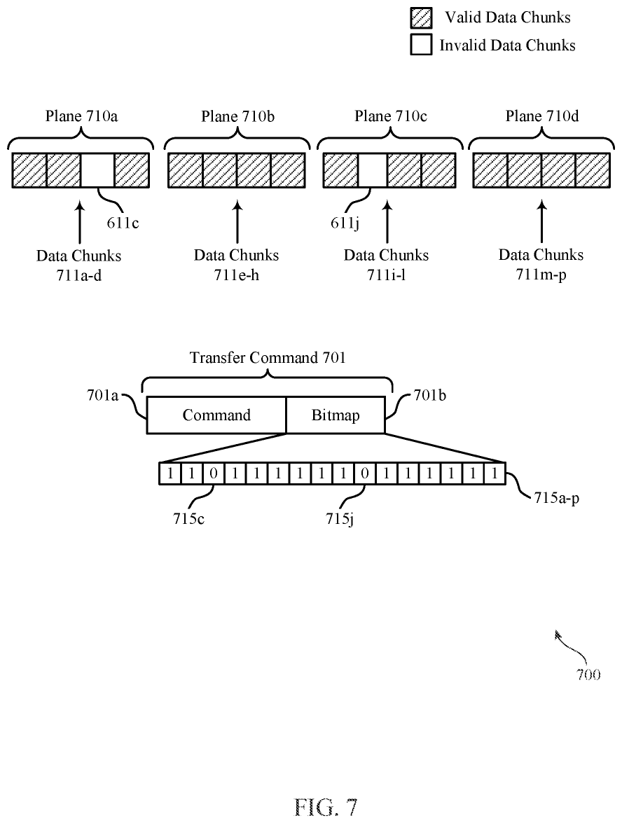

FIG. 7 illustrates an example of a data transfer diagram 700 that supports multiplane data transfer commands in accordance with examples as disclosed herein. The data transfer diagram 700 may be implemented by aspects of the systems 100, 200, and 300 described with reference to FIGS. 1 through 3. For example, the data transfer diagram 700 may be implemented by a memory system, such as a memory system described herein, including with reference to FIGS. 1 through 6.

The data transfer diagram 700 includes a transfer command 701 that supports the transfer of valid data while skipping the transfer of data retrieved as part of a multiplane read operation. For example, the memory system 301 may support a multiplane read operation in which data is read from multiple planes (e.g., planes 321-324), such as reading a pageline of data. In some examples, one or more data chunks of the pageline may include invalid data and should be skipped from being transferred to the memory system controller 315. The transfer command 701 includes a command portion 701a and a bitmap portion 701b. The command portion 701a may correspond to the portions of the transfer command 603 excluding the bitmap 614 described with reference to FIG. 6.

The bitmap portion 701b may correspond to a set of data chunks 711a-p of data retrieved in response to the transfer command 701 (e.g., or in response to one or more sense commands 316) that may be included and excluded from the data transferred to the memory system controller 315 in response to the transfer command 701. In the example of FIG. 7, the data transferred is obtained from four planes 710a-d (e.g., planes 321-324). The data from each plane is divided into four data chunks (although other quantities of data chunks are possible): plane 710a includes data chunks 711a-d, plane 710b includes data chunks 711e-h, plane 710c includes data chunks 711i-l, and plane 710d includes data chunks 711m-p. For example, the data transferred in the example of FIG. 7 may correspond to a pageline of data. That is, data from a page (e.g., page 175) of each plane 710 may be retrieved and transferred to the memory system controller 315.

The memory system 301 (e.g., the memory system controller 315) may generate the bitmap portion 701b to include a bitmap 715a-p with a respective bit corresponding to each of the data chunks 711a-p. In the example of FIG. 7, a bit of the bitmap 715 having a value of ‘1’ (e.g., or ‘0’) may indicate that the corresponding data chunk 711a-p is included in the data transfer from the memory device 302 to the memory system controller 315. Alternatively, a bit of the bitmap 715 having a value of ‘0’ (e.g., or ‘1’) may indicate that the corresponding data chunk 711a-p is excluded from the data transfer from the memory device 302 to the memory system controller 315. For example, bitmap 715a-p may include bits having a value of ‘1’ for all bits except for bits 715c and 715j which have a value of ‘0’. Accordingly, in response to the transfer command 701 and in accordance with the bitmap 715a-p, the data chunks 711a-b, d-i, and k-p may be transferred to the memory system controller 315 and the data chunks 711c and 711j may be excluded from being transferred to the memory system controller 315.

In some examples, the bitmap 715a-p may correspond to data chunks 711a-p in which all of the data chunks contain valid data except for data chunk 711c and data chunk 711j. That is, the bitmap 715a-p may indicate which data chunks 711 include valid data and which data chunks 711 include invalid data. The data chunks 711 containing invalid data may be excluded from the data transfer to the memory system controller 315 in response to the transfer command 701. To support such exclusion from the data transfer, the local controller 312 may adjust the position of a cursor used to indicate which portion of the data is to be transferred via the interface 320. The position of the cursor may be adjusted (e.g., set) such that the portions of the data including invalid data (e.g., data chunks 711c and j) are skipped.

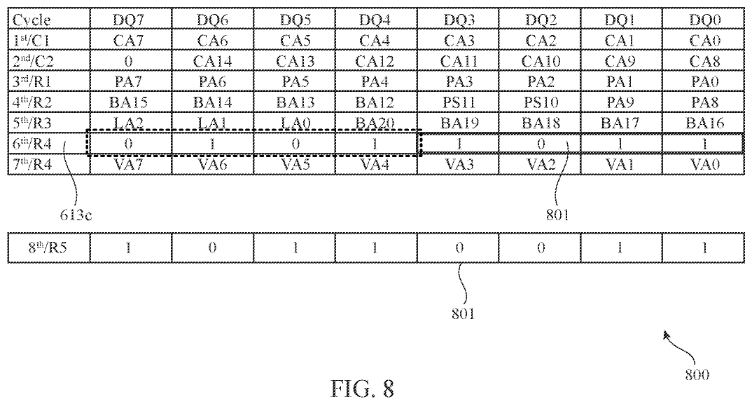

FIG. 8 illustrates an example of a data transfer command 800 that supports systems and techniques for transfer of dirty data in accordance with examples as disclosed herein. The data transfer command 800 may be implemented by aspects of the systems 100, 200, and 300 described with reference to FIGS. 1 through 3. For example, the data transfer command 800 may be implemented by a memory system, such as a memory system described herein, including with reference to FIGS. 1 through 7.

Data contained within the command bytes being transferred from the memory system controller 315 to the local controller 312 may correspond to various bits within the command to be interpreted and used by the local controller 312 to perform an access operation. A particular bit in each cycle is shown in the data transfer command 800, which may be an example of a transfer command 317. The data transfer command 800 may include a bitmap 801 that indicates which portions of data retrieved from one or more planes is to be transferred to the memory system controller 315. In the example of FIG. 8, the bitmap 801 may be included within a cycle (e.g., unit interval) corresponding to column address 613c. The bitmap 801 may correspond to a bitmap 422 used to indicate which data chunks are to be transferred as described with reference to FIGS. 4-7.

The unit interval corresponding to column address 613c may include 4 bits used for the bitmap 801. That is, the memory system controller 315 may issue a transfer command over a set of unit intervals, and the unit interval corresponding to column address 613c (e.g., or some other unit interval over which the transfer commands is issued) may include a subset of bits corresponding to the bitmap 801. For example, if data from a page of a single plane including 4 data chunks is associated with the data transfer, 4 bits of the unit interval may be used to represent the bitmap 801 with each bit corresponding to a respective data chunk of the page.

A bitmap 801 may also include additional bits corresponding to a longer bitmap used, for example, when more than one plane is to be transferred, as described with reference to FIG. 7. Here, additional bits of the unit interval may be included as part of the bitmap 801. For example, each of the 8 bits of the unit interval may correspond to a data chunk retrieved from corresponding plane. In some examples, the data transfer command 800 may be issued over one or more additional unit intervals that are used to indicate a remaining portion of the bitmap 801. For example, if 16 data chunks are to be transferred based on the data transfer command 800 (e.g., 4 data chunks each from 4 planes, such as planes 321-324), the bitmap 801 may include 16 bits. The 8 bits of the unit interval may correspond to the data chunks of two of the planes, and bits corresponding to the data chunks of the other two planes may be issued over an 8^{th} unit interval (e.g., that otherwise would be excluded from the data transfer command 800).

FIG. 9 illustrates a block diagram 900 of a memory system 920 that supports systems and techniques for transfer of dirty data in accordance with examples as disclosed herein. The memory system 920 may be an example of aspects of a memory system as described with reference to FIGS. 1 through 8. The memory system 920, or various components thereof, may be an example of means for performing various aspects of systems and techniques for transfer of dirty data as described herein. For example, the memory system 920 may include a command component 925, an interface component 930, a data transfer component 935, a cursor component 940, a trim component 945, or any combination thereof. Each of these components may communicate, directly or indirectly, with one another (e.g., via one or more buses).

The command component 925 may be configured as or otherwise support a means for issuing, to a first controller of a non-volatile memory device of a memory system, a first command to sense data stored at one or more planes of the non-volatile memory device. The interface component 930 may be configured as or otherwise support a means for transferring, in response to the first command, the data from the one or more planes to an interface between the one or more planes and a second controller of the memory system. In some examples, the command component 925 may be configured as or otherwise support a means for issuing, to the first controller, a second command to transfer one or more portions of the data to the second controller, the second command including a bitmap that indicates the one or more portions of the data to transfer to the second controller. The data transfer component 935 may be configured as or otherwise support a means for transferring, in response to the second command, the one or more portions of the data to the second controller via the interface in accordance with the bitmap.

In some examples, to support transferring the one or more portions of the data from the interface to the second controller, the data transfer component 935 may be configured as or otherwise support a means for transferring a first portion of the data to the second controller in accordance with the bitmap. In some examples, to support transferring the one or more portions of the data from the interface to the second controller, the data transfer component 935 may be configured as or otherwise support a means for skipping the transfer of a second portion of the data to the second controller in accordance with the bitmap.

In some examples, the command component 925 may be configured as or otherwise support a means for generating the second command including the bitmap in accordance with a validity of the data transferred to the interface, the bitmap indicating to transfer valid portions of the data and to skip transferring invalid portion of the data, where the one or more portions of the data indicated by the bitmap correspond to the valid portions of the data.

In some examples, to support transferring the one or more portions of the data from the interface to the second controller, the cursor component 940 may be configured as or otherwise support a means for setting a position of a cursor to a first portion of the data indicated by the bitmap for transfer to the second controller. In some examples, to support transferring the one or more portions of the data from the interface to the second controller, the data transfer component 935 may be configured as or otherwise support a means for transferring the first portion of the data based at least in part on setting the position of the cursor to the first portion of the data, where the position of the cursor is at a second portion of the data after transferring the first portion of the data. In some examples, to support transferring the one or more portions of the data from the interface to the second controller, the cursor component 940 may be configured as or otherwise support a means for setting the position of the cursor to a third portion of the data indicated by the bitmap for transfer to the second controller based at least in part on the bitmap indicating to skip transferring the second portion of the data. In some examples, to support transferring the one or more portions of the data from the interface to the second controller, the data transfer component 935 may be configured as or otherwise support a means for transferring the third portion of the data based at least in part on setting the position of the cursor to the third portion of the data.

In some examples, the position of the cursor is set to the third portion of the data in accordance with a size of a portion of the data indicated by a host system.

In some examples, to support transferring the one or more portions of the data from the interface to the second controller, the data transfer component 935 may be configured as or otherwise support a means for determining to skip transferring a first portion of the data in accordance with the bitmap. In some examples, to support transferring the one or more portions of the data from the interface to the second controller, the cursor component 940 may be configured as or otherwise support a means for setting a position of a cursor to a second portion of the data indicated by the bitmap for transfer to the second controller, where the first portion of the data is skipped from being transferred based at least in part on setting the position of the cursor to the second portion of data. In some examples, to support transferring the one or more portions of the data from the interface to the second controller, the data transfer component 935 may be configured as or otherwise support a means for transferring the second portion of the data based at least in part on setting the position of the cursor to the second portion of the data.

In some examples, the trim component 945 may be configured as or otherwise support a means for receiving, from a host system, a trim command including an indication of a data chunk size, where each bit of the bitmap corresponds to a respective portion of the data having the data chunk size.

In some examples, to support issuing the second command to the first controller, the command component 925 may be configured as or otherwise support a means for issuing the second command over a plurality of unit intervals, where a set of bits of the second command issued over a unit interval of the plurality of unit intervals includes a subset of bits corresponding to the bitmap.

In some examples, to support issuing the second command to the first controller, the command component 925 may be configured as or otherwise support a means for issuing the second command over a set of unit intervals, where the bitmap is issued over one or more unit intervals of the set of unit intervals.

In some examples, each bit of the bitmap corresponds to a respective portion of the data and indicates whether to transfer the respective portion of the data to the second controller.

FIG. 10 illustrates a flowchart showing a method 1000 that supports systems and techniques for transfer of dirty data in accordance with examples as disclosed herein. The operations of method 1000 may be implemented by a memory system or its components as described herein. For example, the operations of method 1000 may be performed by a memory system as described with reference to FIGS. 1 through 9. In some examples, a memory system may execute a set of instructions to control the functional elements of the device to perform the described functions. Additionally, or alternatively, the memory system may perform aspects of the described functions using special-purpose hardware.

At 1005, the method may include issuing, to a first controller of a non-volatile memory device of a memory system, a first command to sense data stored at one or more planes of the non-volatile memory device. The operations of 1005 may be performed in accordance with examples as disclosed herein. In some examples, aspects of the operations of 1005 may be performed by a command component 925 as described with reference to FIG. 9.

At 1010, the method may include transferring, in response to the first command, the data from the one or more planes to an interface between the one or more planes and a second controller of the memory system. The operations of 1010 may be performed in accordance with examples as disclosed herein. In some examples, aspects of the operations of 1010 may be performed by an interface component 930 as described with reference to FIG. 9.

At 1015, the method may include issuing, to the first controller, a second command to transfer one or more portions of the data to the second controller, the second command including a bitmap that indicates the one or more portions of the data to transfer to the second controller. The operations of 1015 may be performed in accordance with examples as disclosed herein. In some examples, aspects of the operations of 1015 may be performed by a command component 925 as described with reference to FIG. 9.

At 1020, the method may include transferring, in response to the second command, the one or more portions of the data to the second controller via the interface in accordance with the bitmap. The operations of 1020 may be performed in accordance with examples as disclosed herein. In some examples, aspects of the operations of 1020 may be performed by a data transfer component 935 as described with reference to FIG. 9.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for issuing, to a first controller of a non-volatile memory device of a memory system, a first command to sense data stored at one or more planes of the non-volatile memory device: transferring, in response to the first command, the data from the one or more planes to an interface between the one or more planes and a second controller of the memory system; issuing, to the first controller, a second command to transfer one or more portions of the data to the second controller, the second command including a bitmap that indicates the one or more portions of the data to transfer to the second controller: and transferring, in response to the second command, the one or more portions of the data to the second controller via the interface in accordance with the bitmap.

Aspect 2: The method, apparatus, or non-transitory computer-readable medium of aspect 1, where transferring the one or more portions of the data from the interface to the second controller includes operations, features, circuitry, logic, means, or instructions, or any combination thereof for transferring a first portion of the data to the second controller in accordance with the bitmap and skipping the transfer of a second portion of the data to the second controller in accordance with the bitmap.

Aspect 3: The method, apparatus, or non-transitory computer-readable medium of any of aspects 1 through 2, further including operations, features, circuitry, logic, means, or instructions, or any combination thereof for generating the second command including the bitmap in accordance with a validity of the data transferred to the interface, the bitmap indicating to transfer valid portions of the data and to skip transferring invalid portions of the data, where the one or more portions of the data indicated by the bitmap correspond to the valid portions of the data.

Aspect 4: The method, apparatus, or non-transitory computer-readable medium of any of aspects 1 through 3, where transferring the one or more portions of the data from the interface to the second controller includes operations, features, circuitry, logic, means, or instructions, or any combination thereof for setting a position of a cursor to a first portion of the data indicated by the bitmap for transfer to the second controller: transferring the first portion of the data based at least in part on setting the position of the cursor to the first portion of the data, where the position of the cursor is at a second portion of the data after transferring the first portion of the data: setting the position of the cursor to a third portion of the data indicated by the bitmap for transfer to the second controller based at least in part on the bitmap indicating to skip transferring the second portion of the data: and transferring the third portion of the data based at least in part on setting the position of the cursor to the third portion of the data.

Aspect 5: The method, apparatus, or non-transitory computer-readable medium of aspect 4, where the position of the cursor is set to the third portion of the data in accordance with a size of a portion of the data indicated by a host system.

Aspect 6: The method, apparatus, or non-transitory computer-readable medium of any of aspects 1 through 5, where transferring the one or more portions of the data from the interface to the second controller includes operations, features, circuitry, logic, means, or instructions, or any combination thereof for determining to skip transferring a first portion of the data in accordance with the bitmap: setting a position of a cursor to a second portion of the data indicated by the bitmap for transfer to the second controller, where the first portion of the data is skipped from being transferred based at least in part on setting the position of the cursor to second portion of the data: and transferring the second portion of the data based at least in part on setting the position of the cursor to the second portion of the data.

Aspect 7: The method, apparatus, or non-transitory computer-readable medium of any of aspects 1 through 6, further including operations, features, circuitry, logic, means, or instructions, or any combination thereof for receiving, from a host system, a trim command including an indication of a data chunk size, where each bit of the bitmap corresponds to a respective portion of the data having the data chunk size.

Aspect 8: The method, apparatus, or non-transitory computer-readable medium of any of aspects 1 through 7, where issuing the second command to the first controller includes operations, features, circuitry, logic, means, or instructions, or any combination thereof for issuing the second command over a plurality of unit intervals, where a set of bits of the second command issued over a unit interval of the plurality of unit intervals includes a subset of bits corresponding to the bitmap.

Aspect 9: The method, apparatus, or non-transitory computer-readable medium of any of aspects 1 through 8, where issuing the second command to the first controller includes operations, features, circuitry, logic, means, or instructions, or any combination thereof for issuing the second command over a set of unit intervals, where the bitmap is issued over one or more unit intervals of the set of unit intervals.

Aspect 10: The method, apparatus, or non-transitory computer-readable medium of any of aspects 1 through 9, where each bit of the bitmap corresponds to a respective portion of the data and indicates whether to transfer the respective portion of the data to the second controller.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal: however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media include both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a non-volatile memory device comprising a first controller; and
a second controller coupled with the non-volatile memory device, wherein the second controller is configured to cause the apparatus to:
issue, to the first controller, a first command to sense data stored at one or more planes of the non-volatile memory device;
transfer, in response to the first command, the data from the one or more planes to an interface between the one or more planes and the second controller;
issue, to the first controller, a second command to transfer one or more portions of the data to the second controller, the second command comprising a bitmap that indicates the one or more portions of the data to transfer to the second controller; and
transfer, in response to the second command, the one or more portions of the data to the second controller via the interface in accordance with the bitmap.

2. The apparatus of claim 1, wherein, to transfer the one or more portions of the data from the interface to the second controller, the second controller is configured to cause the apparatus to:
transfer a first portion of the data to the second controller in accordance with the bitmap; and
skip the transfer of a second portion of the data to the second controller in accordance with the bitmap.

3. The apparatus of claim 1, wherein the second controller is further configured to cause the apparatus to:
generate the second command comprising the bitmap in accordance with a validity of the data transferred to the interface, the bitmap indicating to transfer valid portions of the data and to skip transferring invalid portion of the data, wherein the one or more portions of the data indicated by the bitmap correspond to the valid portions of the data.

4. The apparatus of claim 1, wherein, to transfer the one or more portions of the data from the interface to the second controller, the second controller is configured to cause the apparatus to:
set a position of a cursor to a first portion of the data indicated by the bitmap for transfer to the second controller;
transfer the first portion of the data based at least in part on setting the position of the cursor to the first portion of the data, wherein the position of the cursor is at a second portion of the data after transferring the first portion of the data;
set the position of the cursor to a third portion of the data indicated by the bitmap for transfer to the second controller based at least in part on the bitmap indicating to skip transferring the second portion of the data; and
transfer the third portion of the data based at least in part on setting the position of the cursor to the third portion of the data.

5. The apparatus of claim 4, wherein the position of the cursor is set to the third portion of the data in accordance with a size of a portion of the data indicated by a host system.

6. The apparatus of claim 1, wherein, to transfer the one or more portions of the data from the interface to the second controller, the second controller is configured to cause the apparatus to:
determine to skip transferring a first portion of the data in accordance with the bitmap;
set a position of a cursor to a second portion of the data indicated by the bitmap for transfer to the second controller, wherein the first portion of the data is skipped from being transferred based at least in part on setting the position of the cursor to the second portion of the data; and
transfer the second portion of the data based at least in part on setting the position of the cursor to the second portion of the data.

7. The apparatus of claim 1, wherein the second controller is further configured to cause the apparatus to:
receive, from a host system, a trim command comprising an indication of a data chunk size, wherein each bit of the bitmap corresponds to a respective portion of the data having the data chunk size.

8. The apparatus of claim 1, wherein, to issue the second command to the first controller, the second controller is configured to cause the apparatus to:
issue the second command over a plurality of unit intervals, wherein a set of bits of the second command issued over a unit interval of the plurality of unit intervals comprises a subset of bits corresponding to the bitmap.

9. The apparatus of claim 1, wherein, to issue the second command to the first controller, the second controller is configured to cause the apparatus to:
issue the second command over a set of unit intervals, wherein the bitmap is issued over one or more unit intervals of the set of unit intervals.

10. The apparatus of claim 1, wherein each bit of the bitmap corresponds to a respective portion of the data and indicates whether to transfer the respective portion of the data to the second controller.

11. A non-transitory computer-readable medium storing code comprising instructions which, when executed by a processor of an electronic device, cause the electronic device to:
issue, to a first controller of a non-volatile memory device of a memory system, a first command to sense data stored at one or more planes of the non-volatile memory device;
transfer, in response to the first command, the data from the one or more planes to an interface between the one or more planes and a second controller of the memory system;
issue, to the first controller, a second command to transfer one or more portions of the data to the second controller, the second command comprising a bitmap that indicates the one or more portions of the data to transfer to the second controller; and
transfer, in response to the second command, the one or more portions of the data to the second controller via the interface in accordance with the bitmap.

12. The non-transitory computer-readable medium of claim 11, wherein the instructions to transfer the one or more portions of the data from the interface to the second controller, when executed by the processor of the electronic device, cause the electronic device to:
transfer a first portion of the data to the second controller in accordance with the bitmap; and
skip the transfer of a second portion of the data to the second controller in accordance with the bitmap.

13. The non-transitory computer-readable medium of claim 11, wherein the instructions, when executed by the processor of the electronic device, further cause the electronic device to:
generate the second command comprising the bitmap in accordance with a validity of the data transferred to the interface, the bitmap indicating to transfer valid portions of the data and to skip transferring invalid portions of the data, wherein the one or more portions of the data indicated by the bitmap correspond to the valid portions of the data.

14. The non-transitory computer-readable medium of claim 11, wherein the instructions to transfer the one or more portions of the data from the interface to the second controller, when executed by the processor of the electronic device, cause the electronic device to:
set a position of a cursor to a first portion of the data indicated by the bitmap for transfer to the second controller;
transfer the first portion of the data based at least in part on setting the position of the cursor to the first portion of the data, wherein the position of the cursor is at a second portion of the data after transferring the first portion of the data;
set the position of the cursor to a third portion of the data indicated by the bitmap for transfer to the second controller based at least in part on the bitmap indicating to skip transferring the second portion of the data; and
transfer the third portion of the data based at least in part on setting the position of the cursor to the third portion of the data.

15. The non-transitory computer-readable medium of claim 14, wherein the position of the cursor is set to the third portion of the data in accordance with a size of a portion of the data indicated by a host system.

16. The non-transitory computer-readable medium of claim 11, wherein the instructions to transfer the one or more portions of the data from the interface to the second controller, when executed by the processor of the electronic device, cause the electronic device to:
determine to skip transferring a first portion of the data in accordance with the bitmap;
set a position of a cursor to a second portion of the data indicated by the bitmap for transfer to the second controller, wherein the first portion of the data is skipped from being transferred based at least in part on setting the position of the cursor to the second portion of the data; and
transfer the second portion of the data based at least in part on setting the position of the cursor to the second portion of the data.

17. The non-transitory computer-readable medium of claim 11, wherein
the instructions, when executed by the processor of the electronic device, further cause the electronic device to;
receive, from a host system, a trim command comprising an indication of a data chunk size, wherein each bit of the bitmap corresponds to a respective portion of the data having the data chunk size.

18. The non-transitory computer-readable medium of claim 11, wherein the instructions to issue the second command to the first controller, when executed by the processor of the electronic device, cause the electronic device to:
issue the second command over a plurality of unit intervals, wherein a set of bits of the second command issued over a unit interval of the plurality of unit intervals comprises a subset of bits corresponding to the bitmap.

19. The non-transitory computer-readable medium of claim 11, wherein the instructions to issue the second command to the first controller, when executed by the processor of the electronic device, cause the electronic device to:
issue the second command over a set of unit intervals, wherein the bitmap is issued over one or more unit intervals of the set of unit intervals.

20. A method, comprising:
issuing, to a first controller of a non-volatile memory device of a memory system, a first command to sense data stored at one or more planes of the non-volatile memory device;
transferring, in response to the first command, the data from the one or more planes to an interface between the one or more planes and a second controller of the memory system;
issuing, to the first controller, a second command to transfer one or more portions of the data to the second controller, the second command comprising a bitmap that indicates the one or more portions of the data to transfer to the second controller; and
transferring, in response to the second command, the one or more portions of the data to the second controller via the interface in accordance with the bitmap.
